(19) United States
(12) Patent Application Publication
(10) Pub. No.: US 2020/0340507 A1
(43) Pub. Date: Oct. 29, 2020

(54) Just Click It Magnetic Attachment Device

(71) Applicant: Hiba Kehdy, LaQuinta, CA (US)

(72) Inventor: Hiba Kehdy, LaQuinta, CA (US)

(21) Appl. No.: 16/393,306

(22) Filed: Apr. 24, 2019

(51) Int. Cl. F16B 1/00; F16M 13/02; E05F 5/06; F16B 45/00

(52) U.S. Cl. CPC F16B 1/00; F16M 13/02; H04B 1/3877; F16B 45/00; F16B 2001/0035; E05F 5/06

(57) ABSTRACT

A magnetic device which attaches to the wall and which includes a magnetic holding structure that is a substantially cylindrical or annular shape and enables exchanging different parts including an elastomeric base part that allows the device to function as a doorstop, and a hanger or hook for household items. The device is clicked into place to hold an item in place.

### BACKGROUND

Devices for attaching to the wall typically have required large amounts of manual labor to attach and detach from a wall. As a user's needs change, however, they might want different items located on the walls in different places.

### SUMMARY

The present application describes a magnetic device, referred to as the just click it, which can be easily attached to a wall or other flat surface, and can operate as a doorstop, or as a hook, or as a hanger for a household item, and/or to hold an item into place.

In one embodiment, the device is configured to act as a doorstop.

In another embodiment, the device is configured to act as a removable hanger;

in another embodiment, any household item can be attached to the device

### BRIEF DESCRIPTION OF THE DRAWINGS

FIG. 1 shows a basic layout of the device;

FIG. 2 shows a cross sections;

FIG. 3 shows a front on view of the device is configured to be a doorstop;

FIG. 4 shows a front on view of the device with the hook being attached;

FIG. 5 shows a view of the device configured as a hanger;

FIG. 6 shows the insert being attached to a device that is then magnetically attachable to a wall.

### DETAILED DESCRIPTION

Embodiments are as described herein.

An embodiment describes a base part which is attached to a wall by a removable adhesive. Once the base part is on the wall, a number of different parts can be attached to carry out different functions.

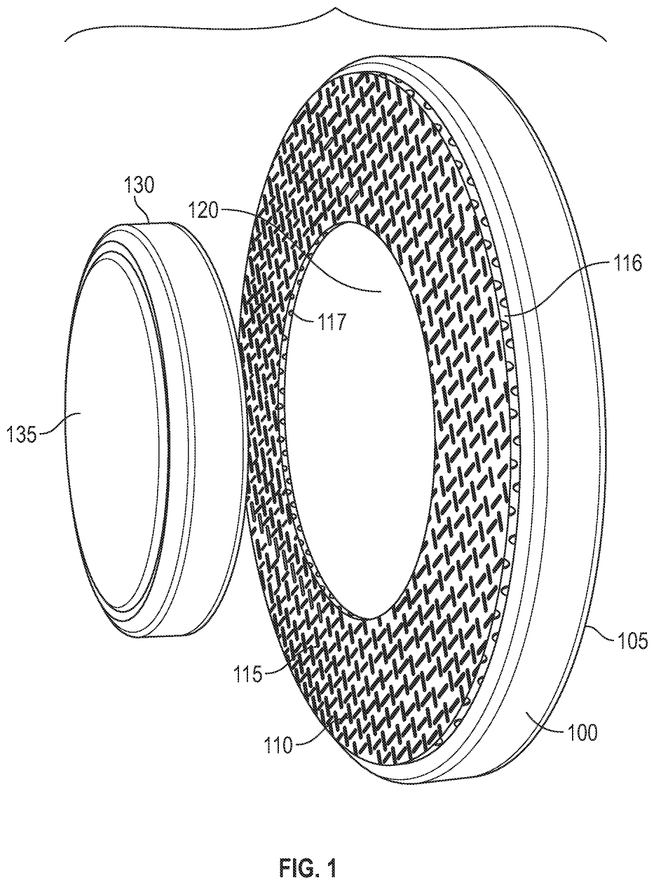

FIG. 1 shows an embodiment, where the base 100 is disk shaped, round in outer circumference, and includes an adhesive pad 105 attached thereon one surface. In an embodiment, the adhesive pad has adhesive that can allow attaching and removing from the wall. The front flat surface 110 of the base 100 includes a rubberized portion 115 forming a generally annularly shaped area extending around a donut shaped area between an outer perimeter portion 116 and an inner perimeter portion 117. Inside the inner perimeter portion 117 is defined an inner area 120, which is a substantially disc-shaped portion, formed of the same material as the base 100, but slightly recessed relative to the outer perimeter portion. For example, this can be a hard plastic or polycarbonate. In an embodiment, one or more of the disc shaped portions can be in vibrant colors. The inner perimeter 117 defines the area of the inner area 120.

An insert 130 fits into the inner area, and is held in the inner area via a magnetic attraction device located within the inner area under the polycarbonate outer shell. There can be different inserts 130, the one shown in FIG. 1 having a rubberized outside portion 135.

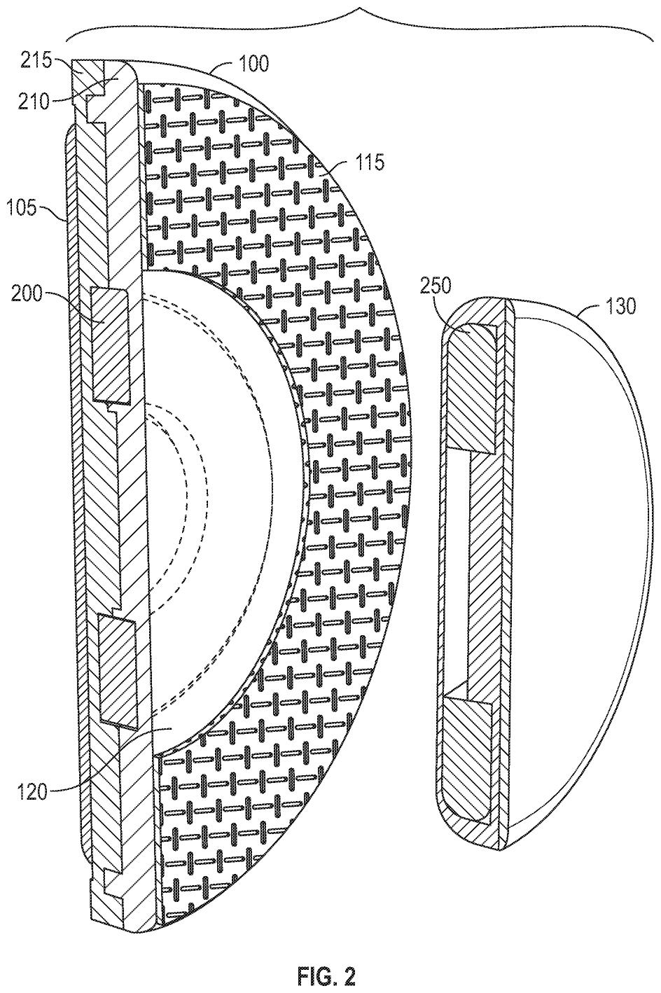

FIG. 2 shows a cutaway portion of the base 100, showing that the base 100 includes the outer rubberized portion 115, and an annular shaped magnet 200 under the surface inside the inner portion 120. This also shows the material of the base itself, showing an upper rubberized surface 210 and a lower support surface 215 which can be of a more rigid material. The attachment adhesive 105 is shown attached to the structural portion 215. In a similar way, the base 135 is shown in cutaway in FIG. 2, and includes an annularly shaped magnet 250, of substantially the same size and shape as the magnet 200, but recessed into the structure of the insert 130.

In one embodiment, shown in FIGS. 1-2, the insert is a doorstop insert, having a substantially flat and rubberized surface.

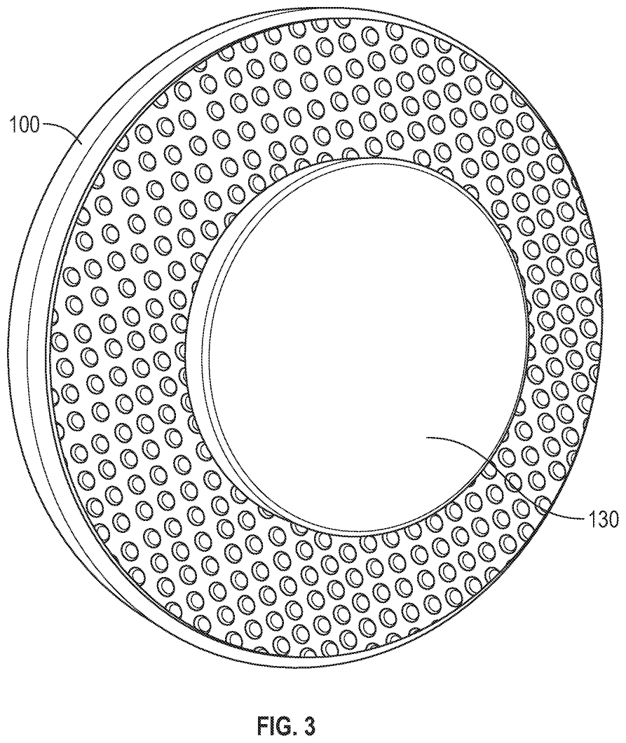

FIG. 3 shows the device, with the base 100 and the doorstop insert 130, where the doorstop insert extends above the surface of the base 100, forming a surface to receive a door handle thereagainst.

In another embodiment, the doorstop can be magnetic, and a magnetic attachment can also be attached to the doorknob. In this way, the door, once opened, is magnetically held in the open position.

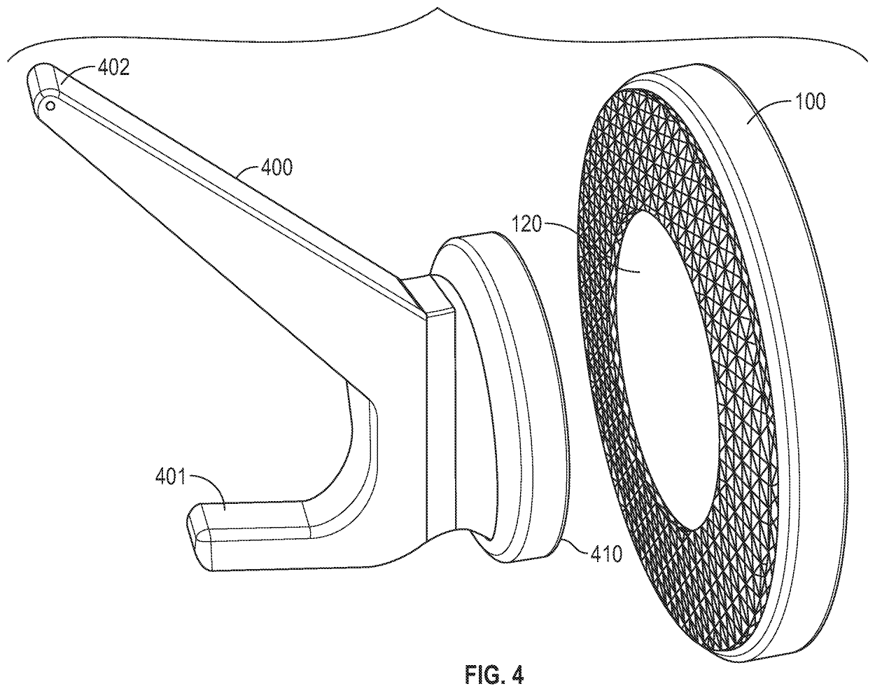

In an alternative embodiment, shown in FIG. 4, the base 100 is identical to the base in the other embodiment, but mates with a hanger for household items shown generally as 400. The hanger for household items includes a magnetic surface 410 of the same size as the insert area 120 in the base and hence the hanger can be attached in place of the doorstop. In this embodiment, the hanger 400 can have a lower hanger part 401 and an upper hanger part 400 to which can allow hanging more than one item or different kinds of items on the respective hanger parts.

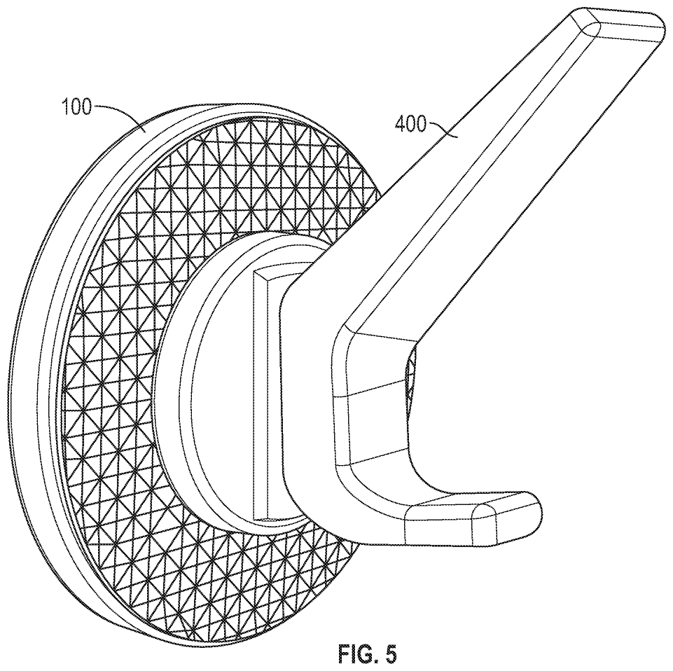

FIG. 5 illustrates the structure of the hanger embodiment as assembled, with the hanger 400 attached to the base 100.

In a similar way, the hanger 400 can be a single part hook.

In another embodiment, the hanger item can be a knob shaped device, which clicks to hold any item in a designated place.

In another embodiment, the insert may be the same size as the base. As explained above, the base and the insert can both be formed of designs and vibrant colors.

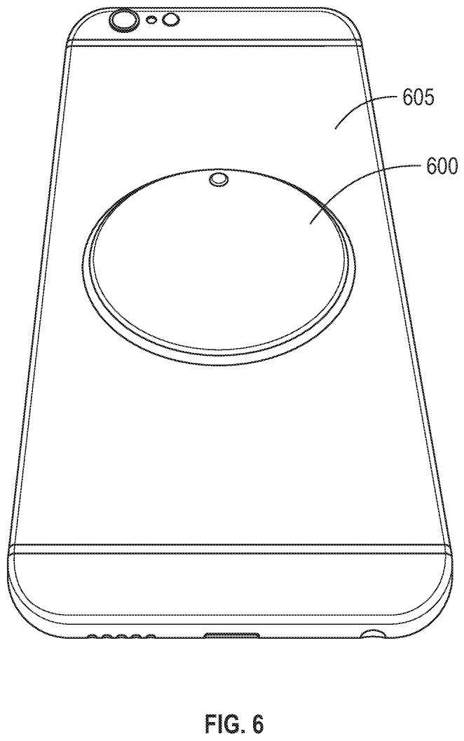

In an embodiment the insert can be attached to an item that holds a household item into place. For example, FIG. 6 shows an embodiment where the insert 600 is magnetic, and is attached to the rear surface of a cellular telephone 605. This enables the telephone 605 to be hung on a wall in any location where the base has been located. In a similar way, any device can be hung from the base by attaching the insert to the device. In all the embodiments, the insert 600 can be any of the colors and his prophetic preferably of vibrant color or pattern, and is attachable to any or all of the devices by removable adhesive.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, the parts can be made of different materials.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
a substantially disk shaped base portion, having a first surface with an adhesive portion thereon, and having a second surface, facing away from the first surface, which has a first portion which is flat and a second portion which is indented, the first flat portion forming an annular ring around the round second portion, and the second indented portion forming a round portion inside the annular ring, recessed relative to the first flat portion;
said base portion including a magnetic portion located in an area of the second portion, extending in a circle in the area of said second portion, and not extending in said first portion; and
an insert portion, having an outer diameter which is which fits within the second portion, and is held magnetically within the second portion, indented below the surface of the first portion, the insert portion having an insert portion which extends above the surface of the first portion.

2. The device as in claim 1, wherein the insert portion is a rubberized portion, forming a doorstop.

3. The device as in claim 1, wherein the insert portion is a hook,

4. The device as in claim 1, wherein the insert portion is a hanger.

5. The device as in claim 1, wherein the magnetic portion is recessed below the second surface and not visible from the second surface.

6. The device as in claim 1, wherein the magnetic portion is annular in shape and extends around a circle defined entirely within the second portion.

7. A device comprising:
a substantially disk shaped base portion, having a first surface with an adhesive portion thereon, and having a second surface, facing away from the first surface, which has a first portion which is flat and a second portion which is indented, the first flat portion forming an annular ring around the round second portion, and the second indented portion forming a round portion inside the annular ring, recessed relative to the first flat portion;
said base portion including a magnetic portion located in an area of the second portion, extending in a circle in the area of said second portion, and not extending in said first portion;
a first insert portion, having an outer diameter which is which fits within the second portion, and is held magnetically within the second portion, indented below the surface of the first portion, the first insert portion having a rubberized portion, forming a doorstop; and
a second insert portion, having an outer diameter which is which fits within the second portion, and is held magnetically within the second portion, indented below the surface of the first portion, the first insert portion having a hook.
